(19) United States
(12) Patent Application Publication
(10) Pub. No.: US 2020/0282741 A1
(43) Pub. Date: Sep. 10, 2020

(54) METHODS FOR IMPROVING IMAGE ADHESION TO SUBSTRATE USING INKJET PRINTING

(71) Applicant: Kornit Digital Ltd., Rosh HaAyin (IL)

(72) Inventors: Nuriel AMIR, Yokneam Ilit (IL); Jacob MOZEL, Kfar-Saba (IL)

(73) Assignee: Kornit Digital Ltd., Rosh HaAyin (IL)

(21) Appl. No.: 16/756,519

(22) PCT Filed: Oct. 16, 2018
(86) PCT No.: PCT/IL2018/051107

§ 371 Date: Apr. 16, 2020

Related U.S. Application Data
(60) Provisional application No. 62/574,219, filed on Oct. 19, 2017.

(51) Int. Cl. B41J 2/21; D06P 5/30; B41M 5/00

(52) U.S. Cl. CPC B41J 2/2114; B41M 5/0047; B41M 5/0017; D06P 5/30

(57) ABSTRACT

Provided herein is a method for digitally printing an image on a substrate in the form of a film attached to the surface of the substrate, such that the film is characterized by improved adhesion and fastness properties also in regions of sparse printing, the method includes digitally printing the image using colored ink composition(s) that comprises a particulate colorant and a binder, and digitally printing selectively a transparent colorless ink composition that includes a binder on regions of impaired adhesion of the image due to sparse printing, such that all parts of the image receive sufficient binding reagents according to a pre-determined threshold.

### FIELD AND BACKGROUND OF THE INVENTION

The present invention, in some embodiments thereof, relates to a method of inkjet printing, and more particularly, but not exclusively, to a method for digital inkjet printing on fabrics of images having sparse printing regions.

Direct inkjet printing on fabrics typically involves forming a film on the surface of the substrate such that the pigment particles are embedded in the film and the film is affixed to the substrate. Adherence of the film is typically achieved by forming bonds between functional groups in the substrate and corresponding functional groups in the material of the film; the film comprises binders and adhesion promoting agents, collectively referred to herein as film-forming agents. Once a “wet” film is printed on the substrate, it undergoes crosslinking which cures the film and forms the bonds with the substrate, whereas curing is typically effected by heat or other forms of energy.

Problems associated with inkjet printing liquid inks directly on absorptive substrates, such as textile and garments, have been mitigated in U.S. Patent Application Publication No. 20150152274, and PCT Application Nos. WO 2005/115089 and WO 2005/115761, by the present assignee, and which are incorporated by reference as if fully set forth herein. These documents teach a process, a composition and an apparatus for printing an image on an absorptive surface, such as an untreated (a substrate that has not been pre-treated chemically) textile piece, that includes applying a wetting composition on the surface which is capable of interfering with the engagement of a liquid ink composition with the binding sites of the surface. According to the processes taught in these patent applications, once the wetting composition is applied, the liquid ink composition is applied while the surface is still wet. Using this process, a vivid color image is formed on the absorptive surface. These patent applications, however, fail to address printing a color image on an absorptive dark surface.

Multi-part ink compositions, which are based on contacting an immobilizing composition and a colored ink composition on the surface of an untreated substrate, so as to congeal the colored ink composition on the substrate, thereby minimizing feathering and soaking thereof into absorptive substrates, are also taught in U.S. patent application Ser. No. 11/588,277 (U.S. Patent Application Publication No. 20070104899), and U.S. patent application Ser. No. 11/606,242 (U.S. Patent Application Publication No. 20070103529), all of which are incorporated by reference as if fully set forth herein.

Problems associated with inkjet printing transparent liquid inks directly on dark substrates, such as dyed textile and garments, have been mitigated in U.S. Pat. No. 7,134,749, by the present assignee, which is incorporated by reference as if fully set forth herein. This document teaches a method and an apparatus for color printing on an untreated dark textile piece which includes digitally printing, by means of an inkjet printer head, an opaque white ink layer directly onto the untreated dark textile piece, and digitally printing a colored image on the white ink layer.

U.S. Pat. No. 8,540,358, by the present assignee, which is incorporated by reference as if fully set forth herein, teaches an inkjet ink compositions for forming an image in a form of an elastic film attached to a surface of an untreated stretchable and/or flexible substrate and processes utilizing same for inkjet printing color images on various substrates such as colored and absorptive or impregnable stretchable materials, which are characterized by heightened efficiency in process time, ink and energy consumption, as well as products having durable, wash-fast and abrasion-fast images printed thereon by the process, are disclosed.

As presented hereinabove, inkjet printing on textile and other absorptive, flexible and stretchable substrates presents wide spectrum of challenges, including image resolution, color gamut, stretchability and robustness (adhesion to the substrate, wash-fastness as well as rub-fastness). The wash-fastness and rub-fastness of an image drives inter alia from the mechanical properties of the film which is formed on the surface of the substrate as a result of the printing process.

In general, an image has regions of intense and less intense coloration and brightness, for example, near the edge of the image or in design elements that are fading into the background. These regions are formed on the surface of the substrate using fewer droplets of inkjet ink being jetted onto the surface; hence, these regions also receive a smaller amount of binder materials, compared to bright and/or intense colored regions in the image. Regions of such sparse printing oftentimes exhibit a thinner film which exhibits a lesser adhesion power, compared to other regions in the film; in turn, these regions are more prone to peeling and discoloration as a result of wear and tear, and washing.

Thus, while the majority of the abovementioned solutions have succeeded in improving many aspects in inkjet printing technology, including bleed-free image film formation on dark and/or stretchable substrates, the resulting film remained vulnerable to rubbing and repeated washing, and the problem of integrity, thickness and continuity in sections of sparse printing in the image has not yet been solved.

### SUMMARY OF THE INVENTION

Aspects of the present invention are drawn to a solution to the problem of image wash- and rub-fastness stemming from lacking in integrity, thickness and continuity on certain sections of sparse printing in the image due to the design. To strengthen the adhesion and wash-fastness, there is a minimum amount of ink needed. When printing a very light color without a white underbase layer, or with sparse drops which are not connected, there is not enough binder to ensure adhesion to the fabric since the film in these sections is too thin and/or discontinuous. According to some embodiments of the present invention, adding binder without changing the color provides the minimal, optimal or even excessive amount needed to ensure sufficient integrity, thickness and continuity of the film in these sections of the image. The addition of a clear (colorless) adhesive curable binder composition (inkjet ink) enables strengthening the film in these sections and results in acceptable wash-fastness with null or negligible effect to the color of the image according to its design.

According to an aspect of some embodiments of the present invention there is provided a method for inkjet printing an image on a surface of a substrate; the method includes digitally printing the image on at least a portion of the surface using at least one colored ink composition, which includes a particulate colorant and a binder, and digitally printing a transparent colorless ink composition on at least a portion of the image, wherein:

the transparent colorless ink composition includes a binder and is essentially devoid of a colorant;

digital printing of the transparent colorless ink composition is effected on at least one region of impaired adhesion of the image that includes at least one region of sparse printing, the region of sparse printing is characterized by receiving a total amount of colored ink composition(s) lower than a threshold; and a total of the regions of impaired adhesion is equal or larger than a total of the regions of sparse printing, and overlap less than 100% of the image.

According to some embodiments of the invention, the threshold is a minimal or optimal amount of the at least one colored ink composition that is sufficient for passing a fastness test.

According to some embodiments of the invention, the threshold is determined experimentally.

According to some embodiments of the invention, the printing resolution of the colored ink composition(s) is equal to the printing resolution of the transparent colorless ink composition.

According to some embodiments of the invention, the printing resolution of the colored ink composition(s) is different than a printing resolution of the transparent colorless ink composition. According to some embodiments of the invention, the printing resolution of the transparent colorless ink composition is lower than the printing resolution of the colored ink composition(s).

According to some embodiments of the invention, the region(s) of impaired adhesion and the region(s) of sparse printing are co-extensive (overla0).

According to some embodiments of the invention, the region(s) of impaired adhesion are larger than the region(s) of sparse printing.

According to some embodiments of the invention, digitally printing of the transparent colorless ink composition is effected while the surface is still wet with the colored ink composition(s); digital printing of the colored ink composition(s) is effected while the surface is still wet with the transparent colorless ink composition.

According to some embodiments of the invention, the method presented herein further includes curing the image after the digital printing.

According to some embodiments of the invention, the method presented herein further includes, prior to inkjet printing the image, digitally analyzing a digital form of the image having pixel positioning data and information of the total amount of colored ink composition(s) per each pixel of the image, the analyzing is for identifying the region(s) of sparse printing and determining the regions of impaired adhesion and the minimal or optimal amount of the transparent colorless ink composition per pixel of the image, based on the threshold.

According to an aspect of some embodiments of the present invention there is provided a method for identifying at least one region of sparse printing in an image; the method includes analyzing a digital form of the image having positional data and information of the total amount of colored ink compositions per each pixel of the image, and listing each of the pixels in which the total amount of the at least one colored ink composition is lower than a predetermined threshold.

According to some embodiments of the invention, the threshold is determined experimentally by digitally printing at least one colored ink composition on the substrate in a predetermined series of shapes, each shape is printed at a different percent ink coverage, curing the printed shapes on the substrate, subjecting the substrate having the cured shaped thereon to a fastness test, and by analyzing the effect of the fastness test, identifying the minimal and/or optimal percent of ink coverage, thereby determining the threshold.

According to an aspect of some embodiments of the present invention there is provided a product produced by the method presented herein, wherein the image is characterized by having at least one region of impaired adhesion, identified by a film afforded by curing the transparent colorless ink composition.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### DESCRIPTION OF SOME SPECIFIC EMBODIMENTS OF THE INVENTION

The present invention, in some embodiments thereof, relates to a method of inkjet printing, and more particularly, but not exclusively, to a method for digital inkjet printing on fabrics of images having sparse printing regions.

The principles and operation of the present invention may be better understood with reference to the accompanying descriptions.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

As presented hereinabove, direct inkjet printing of inks comprising particulate colorants on untreated fabrics has enjoyed the improvements provided by the aforementioned technologies, since the emulsified and/or suspended colorant particles are required to be affixed to the substrate by means of film-forming agents (adhesion agents and/or binders), forming a transparent film that binds the colorant particles while adhering to the substrate; in cases where the substrate is not white, the process is supplemented by an opaque white underbase layer. Some of the aforementioned technologies utilizing property-sensitive variants of emulsified film-forming adhesion agents and film-forming binders and/or dispersants of the suspended colorant particles, wherein these variants can lose their solubility in the ink's medium when contacted with a property-adjusting agent (e.g., an acid), and thereby cause coagulation of the ink composition on the surface of the substrate. In addition, the aforementioned technologies are based on the ability to crosslink the various ingredients of the film amongst themselves and with the substrate, which is obtained by using a crosslinking agent which cures the film at elevated temperatures. None of the aforementioned technologies and methodologies provide a solution to the problem of poor film fastness in regions of sparse printing in the image.

The present inventors have recognized that indiscriminant addition of binder to the film during the printing process may solve the problem of sparse printing, but at the expense of forfeiting some of the most important advantages of inkjet technology, such as pleasant hand feel and breathability, since indiscriminant addition of binder to the entire area covered by the image will make the film thicker all over. In addition, the printing process will take more time and run up binder costs.

While conceiving the present invention, the inventors have contemplated using the digital information present in the Raster Image Processor (RIP) output, which includes all data needed for driving the printing machine and forming the image on the substrate. The inventors have contemplated analyzing the printer instructions for forming the film, in terms of the amount of ink per pixel, while postulating that the amount of ink per pixel can serve as an indication for the amount of binder material received at each of these area unit. It is noted herein that a typical RIP output contains all information relating to the digital rendition of the image, including a bitmap, pixel resolution, overall coverage area (silhouette), external and internal edges, background color, process color composition and the like; this information is used by the printing machine to determine where and how much of each process colored ink composition to inkjet at each area unit (pixel).

While further conceiving the invention, the inventors have contemplated a digital method for strengthening the adhesion of the ink in regions of sparse printing, which is effected by digitally identifying these regions and treating these regions so as to receive at least a minimal or optimal amount of binder that ensures sufficient adhesion of the film to the substrate that complies with fastness requirements and standards. In some embodiments of the present invention, this digital adhesion strengthening is achieved by creating an addition to the RIP that controls the printing of a transparent colorless ink composition that comprises a binder.

General Terminology and Definitions:

The color mixing method commonly used in printing is known as subtractive primary colors model. Typically an inkjet printing system includes a set of colored ink compositions, one for each of the primary colors used to create an almost complete spectrum of colors, or color space. The most commonly used in printing is the CMYK color model. The black is referred to as “K” for key (shorthand for the printing term “key plate” which was used to impress the artistic detail of an image, usually in black ink). “C” stands for cyan; “M” stands for magenta and “Y” stands for yellow. In the direct printing method such as inkjet printing, the formation of the image is achieved by placing ink drops of the primary colors on the surface at different adjacent sites as discrete (non-mixed) drops. In inkjet printing, each drop plays the role of a single distinct colored object according to the primary color ink it is made of. Due to the small size and spatial proximity, several drops of different color inks may be perceived by the human eye as one combined subtractive or filtered color.

Opaque inks reflect light wavelengths, while transparent inks transmit light wavelengths to the object's surface. The term “transparent”, as used herein, refers to an ink, a material or an article, allowing light to pass through so that objects behind can be seen; the term “transparent” is used in the sense of translucency, the physical property of allowing the transmission of light through a material. The term “opaque”, as used herein, refers to an ink, a material or an article, which is not transparent, namely not able to be seen through. Therefore, when using transparent ink compositions, the color of object's surface has a principal influence on the perceived color, and thus is usually opaque white, or at least lightly colored. In that case, the viewer receives the reflected light from the substrate. For example, if a white substrate is painted with pure blue transparent ink, the ink layer absorbs the ambient light, allowing only the blue light to be transmitted to the substrate. The blue light is then reflected by the opaque white substrate, back through the ink and into the viewer's eyes, and perceived by the viewer as blue color.

The term “colorless”, as used herein in the context of an ink composition, refers to an ink composition lacking an addition of a colorant. In other words, a colorless ink composition imparts no color on the substrate and makes no, or marginal difference in term of color when added to, or printed near another ink composition. In the context of Lab color space (CIELAB), a colorless ink composition is characterized by imparting to a receiving substrate infinitesimal a* and b* values, or very low a* and b* values.

As used herein, the term “CIE Lab”, “L*a*b*” or “Lab*” refers to the CIE L*a*b* (International Commission on Illumination or Commission Internationale d'Eclairage (CIE)) color model. Used interchangeably herein and throughout, CIE L*a*b*, L*a*b* or Lab is the most complete color model used conventionally to describe all the colors and shades which are typically visible to a normal human eye. The three parameters in the model define a particular color, whereas the lightness of the color is represented by the parameter L*, wherein L*=0 corresponds to black and L*=100 corresponds to white. The value between true magenta and true green is represented by the parameter a*, wherein a negative value indicates green and a positive value indicates magenta. The value between true yellow and true blue is represented by the parameter b*, wherein a negative value indicates blue and a positive value indicates yellow.

In the context of the present invention, a colored ink composition can be a standard colored inkjet composition or a modified version of a standard inkjet composition, and can be any transparent/translucent colored liquid ink composition, any semi-transparent colored liquid ink composition or any opaque colored liquid ink composition. Preferably the colored ink composition comprises one or more colorants, and more preferably, the colorant is a particulate colorant, such as pigments and/or dye-encapsulating particles. According to some embodiments, the colored ink composition is formulated so as to comply with the requirements imposed by the inkjet printhead and other machinery parts, such as viscosity, corrosion, particles, wetting and the like.

The term “colorant”, as used herein, describes a substance which imparts the desired color to the printed image. The colorant may be a particulate colorant or a dye. Particulate colorants are solid particles characterized by an intense and dense color that can be affixed to a substrate typically as part of a film made from a resin and/or film-forming binders and/or adhesion-promoting agents and/or crosslinking agents. Pigments are solid particulate colorants having a distinct color, which are typically suspended/dispersed in the carrier of the ink composition, whereby dyes are liquid colorants, which are dissolved or emulsified in the carrier of the ink composition. According to embodiments of the present invention, the colorant is a solid colorant in the form of a dispersed pigment. According to some embodiments of the present invention, the colorant is a solid dispersed particle shell (e.g., silica, polymeric or otherwise) encapsulating a dye (e.g., an organic dye molecule, a fluorescent dye and the likes), that is otherwise insoluble or in-dispersible in the ink's medium.

In the context of the present invention, a transparent colorless ink composition comprises the same or similar ingredients and have the same or similar properties of a colored ink composition, except the presence of a colorant therein. In general, the role of the transparent colorless ink composition, according to embodiments of the present invention, is to deliver a binder to a certain region on the substrate or the image being printed thereon; hence, the transparent colorless ink composition includes, among other optional ingredients, a binder and a carrier. In some embodiments, the transparent colorless ink composition is essentially devoid of a colorant, and preferably essentially devoid of a colorant. According to some embodiments, the transparent colorless ink composition is formulated so as to comply with the requirements imposed by the inkjet printhead, such as viscosity, corrosion, particles, wetting and the like.

The term “binder”, as used in the context of the present invention, refer to any substance or a mixture of substances that promote the formation of a film on the substrate, and/or promote the adhesion of the film to the substrate. Each of the terms “binder” and “a binder”, encompasses adhesion promoting agents, film-forming agents, binders, resins and the likes, all of which are known in the field of inkjet printing to promote film formation and/or film adhesion to a substrate. In the context of embodiments of the present invention, a colored ink composition comprises particulate colorant(s), dispersant(s), binder(s), humectant(s), various additives and a carrier, and the transparent colorless ink composition comprises essentially the same ingredients except colorant(s); thus, when adding binder to certain regions of the image, one can print the transparent colorless ink composition in addition to the colored ink composition, particularly in regions which receive less than the threshold amount of the colored ink composition. Accordingly, in the context of embodiments of the present invention, a step of digitally printing a transparent colorless ink composition on a specified region in the image is equivalent to a step of adding binder to that region.

Selective Addition of Binder:

The present invention is drawn, in some embodiments thereof, to a method of direct digital printing of an image on a substrate, designed to improve film adhesion of the image's film, particularly in regions of sparse printing, while refraining from off-line pretreatment of the substrate, and refraining from indiscriminately covering the entire printing area (the entire image) with additional binder. In some embodiments, the method includes digital inkjet printing a transparent colorless ink composition that comprises a binder, before, during or after digital inkjet printing at least one colored ink composition that comprises a particulate colorant, such as a pigment, and a binder, wherein printing the transparent colorless ink composition is effected on areas of the image referred to herein as “regions of impaired adhesion”.

In the field of inkjet printing, the amount of ink per unit area of receiving medium (substrate) is commonly referred to in terms of percent coverage, whereas an area that is fully covered by ink is 100% covered or more, and an area that receives no ink is 0% covered. The term “regions of sparse printing”, as used herein, refers to regions in a printed image that is characterized by receiving a low amount of ink, relative to other regions in the image, or in terms of percent coverage, receive below a certain percentage of coverage, also referred to herein as a threshold. Alternatively, a region of sparse printing refers to a region in a printed image that is characterized by receiving an amount of ink or binder that is not sufficient (too low; below threshold) to afford acceptable adhesion of the resulting film therein. Further alternatively, a region of sparse printing refers to a region in a printed image that is characterized by receiving less than a threshold amount of ink or binder therein, as this term is defined and discussed hereinbelow. The regions of sparse printing, and in some cases regions proximal thereto, are prone to suffer from impaired adhesion, and therefore may require an additional amount of binder to enhance film adhesion therein.

The method presented herein is designed to refrain from impairing the hand feel and/or breathability of the finished product, and particularly that of the image's surface, and is further designed to render the printing process efficient in terms of printing time and binder usage. According to some embodiments of the present invention, the term “regions of impaired adhesion” refer to regions in the image that include regions of sparse printing. In the alternative, the term “regions of impaired adhesion” corresponds to the term “regions of sparse printing” in the sense of area coverage, and can refer to regions that are smaller than, substantially co-extensive (overlap) and/or substantially encompass and extend beyond the regions of sparse printing. In some embodiments, the regions of impaired adhesion encompass the regions of sparse printing and a marginal/peripheral area around the regions of sparse printing. In some embodiments, the regions of impaired adhesion also encompass regions that do not fall under the definition of areas of sparse printing; this is due to proximity to regions of sparse printing, area shape, printing resolution and other considerations.

In some embodiments, the method presented herein is based on digitally printing the transparent colorless ink composition only on at least one region of impaired adhesion of the image that includes at least one region of sparse printing.

In some embodiments, the method presented herein is effected by adding binder to, or digitally printing a transparent colorless ink composition on a total area that is smaller than, equal or larger than a total of the regions of sparse printing, and overlaps less than the entire image. In some embodiments, the transparent colorless ink composition is added to less than 100% of the area of the image, or less than 95% of the image, or less that 90%, 85%, 60%, 75%, 70%, 65%, 60%, 55%, 50%, 45%, 40%, 35%, 30%, 25%, 20%, 15%, 10%, or less than 5% of the total area of the image.

In some embodiments, the method presented herein is effected by adding binder to, or digitally printing a transparent colorless ink composition on a total area of regions of impaired adhesion that is equal or larger by no more than 50% of the total area of the regions of sparse printing of the image. Alternatively, the binder is added to a total area that is larger by no more than 40%, 30%, 20%, 10% or 5% of the total area of the regions of sparse printing. In some embodiments, binder is added substantially to the regions of sparse printing in the image.

It is noted herein that in some regions of the image that are bordering or surrounded by regions of sparse printing, or at and near the edge of the image, may require additional binder, according to a proximity criterion; therefore in some embodiments such regions are considered regions of impaired adhesion even if they receive sufficient amount of colored ink composition. A proximity reference can be a margin of at least 1, 2, 3, 4, 5, 6, 7, 8, 9 or at least 10 pixels around or adjacent to the regions of sparse printing or the edges of the image.

In some embodiments, binder is added by digitally printing a transparent colorless ink composition substantially on the regions of sparse printing in the image, as well as to the regions in proximity thereto; namely, binder is added to regions of sparse printing and to a margin of at least 1, 2, 3, 4, 5, 6, 7, 8, 9 or at least 10 pixels around or adjacent to the regions of sparse printing. These margins are considered part of the regions of impaired adhesion.

In some embodiments, mapping the regions of sparse printing, based on the information in the RIP output, is effected at the resolution of the bitmap of the RIP, namely the mapping is at the resolution level of the image as it is digitized and stored in the RIP. The smallest unit area is typically referred to as a pixel, and it is the resolution at which the printing machine is operated to form the image. In other words, the regions of sparse printing are defined by area unit corresponds to the resolution of the printing machine, wherein the smallest digitally analyzable and treatable (printable) area unit is one pixel.

In some embodiments, the regions of impaired adhesion are defined by an area unit that are different than that used to define the regions of sparse printing. This difference can be expressed in the operation resolution of the colored ink printheads, compared to the operation resolution of the transparent colorless ink printheads. In other words, the image can be formed by printing the colored ink composition at a different resolution (smallest area unit size) compared to the printing resolution of the binder-containing transparent colorless ink composition. In embodiments where the smallest area unit size of the transparent colorless ink composition is larger than the smallest area unit size of the colored ink composition, the regions of impaired adhesion can be printed at a faster rate than the image. In the context of some embodiments of the present invention, the resolution of the colored ink compassion(s) is similar to the resolution of the transparent colorless ink composition, and the size of the pixel for printing each of the compositions is essentially identical.

Sparse Printing Threshold:

Some embodiments of the present invention are optionally based on determining the above-mentioned minimal or optimal amount of binder that provides sufficient adhesion of the film to the substrate. This amount is referred to herein as the sparse printing threshold amount, or simply referred to as threshold amount or threshold, which can be determined either arbitrarily, by a preset standard, or experimentally by a simple wash- or rub-fastness testing procedure, as described hereinbelow.

In some embodiments thereof, the method utilizes the results of a threshold criteria procedure (TCP). A typical TCP is an experimental procedure that is executed at least once per a complete system that includes a particular printing machine setup (drop size, ink density or percent coverage, and frequency, curing temperature and curing time), a particular substrate (cotton, polyester, viscose, blend type, etc.) and a particular set of inks (particulate colorant, dispersants, binder, crosslinking agents, additives, carrier and the like). For example, a series of shapes, such as 1×1 cm squares, is printed using the selected machine and selected inks on the selected substrate, wherein the printing parameters of each shape are different than the other only by the amount of ink used for printing the shape (each shape is printed at a difference percent coverage). This amount can also be expressed as a “per unit area” or “per pixel” amount. Thereafter, the printed substrate is subjected to any protocol for fastness testing, which can be any widely accepted fastness testing standard known in the art. The TCP determines minimal (or optimal) amount (threshold) of ink that needs to be placed on a given area or pixel in order to comply with the required fastness standard.

The threshold is quantified per unit area which can be the smallest digital unit area (pixel) or any unit area relevant to the printing machine parameters (e.g., percent coverage per square inch). Thus, the terms “threshold” and “threshold amount” (hereinafter value t), used herein interchangeably, refer to the minimal or optimal amount of binder per unit area (e.g., one pixel, a group of pixels and the like) needed to achieve a required film fastness. The threshold can be determined quantitatively as a minimal or optimal percentage of coverage by ink per unit area of substrate's surface, as described hereinabove. Alternatively, the terms “threshold” and “threshold amount” refer to the minimal or optimal amount of binder per any given unit area necessary for withstanding a standard fastness test, e.g., a wash-fastness test, or in other words, the threshold is defined as the minimal or optimal amount of binder required to achieve an acceptable fastness score. It is noted herein that in some embodiments of the present invention, the amount of binder can be represented by the amount of ink, since the amount of binder in each colored ink is similar, and assessing the amount of ink in relative “per area unit” terms is closely correlated to assessing the amount of binder in relative “per area unit” terms. For example, if the method requires to map all pixels with lower than threshold amount of binder, this mapping can be achieved by mapping all pixels with lower than threshold amount of total colored inks.

Standard Fastness Tests:

In the context of embodiments of the present invention, color fastness or simply fastness, refers to the resistance of printed color to fade due to the influences of various factors, such as water, light, rubbing, washing, perspiration etc., to which the printed substrates are normally exposed in manufacturing and in daily use. Types of color fastness include wash fastness, rub fastness, light fastness, perspiration fastness, water fastness, and color fastness to bleaches and chemicals.

In the context of some embodiment of the present invention, standard color fastness includes wash fastness and rub fastness, which are mostly affected by the level of adhesion of the film to the substrate. In general, any type of fastness can be assessed and tested for qualifying a desired standard, using a color fastness testing method; a printing result obtained from any given combination of printing process parameters, ink composition and substrate, can be tested for any color fastness criteria, whereas passing a fastness test is indicative of using sufficient amount of ink or binder at the tested region.

It is noted that any color fastness testing method is applicable in the context of some embodiment of the present invention, including proprietary and publically available methods, as well as standard methods known in the field of textile and printing.

Standard test methods for color wash fastness include, without limitation:

### 1. AATCC Test Method 61—Test No. 1A or Test No. 2A;

### 2. ISO Test Method 105 C-06—1A or 2A; and

### 3. CAN/CGSB Test Method 19 (#2).

Standard test methods for color fastness to rubbing include, without limitation:

1. ISO 105—X12 2002: Color fastness to rubbing;
2. ISO 105—X16: Color fastness to rubbing;
3. AATCC 8:2005: Color fastness Crocking;
4. AATCC 116-2005: Color fastness to Crocking; and

### 5. AATCC 165-1999.

In the context of embodiments of the present invention, the threshold amount of binder can be determined based on an arbitrarily fastness score set by the user, or based an acceptable fastness score that complies with any fastness scoring methodology, such as the abovementioned fastness standards.

Digital Image Analysis:

According to some embodiments of the present invention, the method in implemented by digitally analyzing the image prior to its printing in order to identify the region(s) of sparse printing and determining the region(s) of impaired adhesion. The digital analysis is then used to determine the minimal or optimal amount of the transparent colorless ink composition which will be added to each pixel of the image in the region(s) of impaired adhesion, based on a pre-determined threshold.

A digital analysis of the image prior to its printing may be executed by using the RIP (Raster Image Processor) information as input for an image analysis and processing algorithm. The RIP is a digital form of the image that can be processed by a computer-borne algorithm, and includes pixel position data and color-per-pixel information, namely the total amount of the colored ink composition(s) per each pixel of the image. The algorithm is used to calculate the minimal or optimal amount of the transparent colorless ink composition that will be printed in the region(s) of impaired adhesion, based on a pre-determined threshold.

An exemplary algorithm is presented in Example 1 hereinbelow. It is to be understood that the method presented herein is not limited to any particular algorithm, and can be implemented using any computerized (digital) algorithm, as well as any non-digital image analysis methodology.

Process of Printing:

According to some embodiments of an aspect of the present invention, there is provided a process of inkjet printing an image on a surface of a substrate, which is carried out by implementing the method presented herein. The process includes:

analyzing the image, either digitally or otherwise, in order to identify the position of the region(s) of sparse printing, determine the position of region(s) of impaired adhesion, and to determine the minimal or optimal amount of the transparent colorless ink composition that will be added to the region(s) of impaired adhesion based on a pre-determined threshold;

digitally printing at least one colored ink composition on the substrate;

digitally printing the transparent colorless ink composition on at least one region of impaired adhesion of the image that includes at least one region of sparse printing that is characterized by receiving a total amount of the colored ink composition(s) that is lower than the threshold, as these terms are defined hereinabove; and

curing the wet image to thereby obtain the image in the form of a film attached to the surface of the substrate.

In some embodiments, the process further includes applying or printing an immobilizing composition on the surface of the substrate, at least in the area(s) on which the image is printed, as disclosed in any of U.S. patent application Ser. No. 11/588,277 (U.S. Patent Application Publication No. 20070104899), U.S. patent application Ser. No. 11/606,242 (U.S. Patent Application Publication No. 20070103529), and U.S. Pat. No. 8,540,358, all of which are incorporated by reference as if fully set forth herein.

In some embodiments, the process further includes printing an opaque white underbase ink composition on the surface of the substrate, at least in the area(s) on which the image is printed of, particularly when inkjet printing transparent liquid colored ink compositions on dark substrates, as disclosed in U.S. Pat. No. 7,134,749, which is incorporated by reference as if fully set forth herein.

According to embodiments of the present invention, each of the compositions that are used to form the image on the surface of the substrate, can applied or printed while the substrate is still wet with any of the other compositions that had been already applied or printed hereon. In some embodiments, except when using an opaque white underbase ink composition, all compositions can be applied or printed on the substrate in any sequential order, or concomitantly, or simultaneously; whereas the opaque white underbase ink composition is printed before the colored ink composition(s). For example, the immobilizing composition can be applied or digitally printed on the surface of the substrate prior to, simultaneously, or shortly after any of the colored ink composition and/or the transparent colorless ink composition are printed thereon. In the alternative, the transparent colorless ink composition is printed on the surface of the substrate after the immobilizing composition and prior to the colored ink composition.

Product by Process:

According to an aspect of some embodiments of the present invention, there is provided a product produced by the method and process of inkjet printing an image on a surface of a substrate, as described in the foregoing. In general, the product is a piece of textile, or a garment, having an image and/or a pattern printed thereon that have been afforded by digital inkjet printing process, wherein the image is characterized by having regions of sparse printing, which are reinforced for improved fastness during the process by printing thereon and elsewhere in the image (regions of impaired adhesion) a transparent colorless ink composition, that is essentially devoid of a colorant. The additional binder is added to the regions of impaired adhesion in an amount that is at least equal or larger than the threshold amount, as described in the foregoing.

According to some embodiments of the present invention, the product described herein can be identified and distinguished from other products which have been afforded by known methodologies and not by the foregoing method and process, by analyzing areas in the image with relative low percent ink coverage (regions of sparse printing; regions expected to receive less than the threshold amount of binder), and finding more binder, in the form of colorless and transparent film, than can be expected from the amount of binder stemming from the colored ink printed therein. In some embodiments of the present invention, the product produced by the methodology presented herein is expected to exhibit at least some regions having a colorless and transparent film near and/or around regions of sparse printing, which are not expected to be present in products which have been afforded by known methodologies and not by the foregoing method and process.

It is expected that during the life of a patent maturing from this application many relevant methods for inkjet printing of wash-fast images with improved film adhesion will be developed and the scope of the term “methods for inkjet printing of wash-fast images” is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or, in the alternative, includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

The term “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the terms “process” and “method” refer to manners, means, techniques and procedures for accomplishing a given task including, but not limited to, those manners, means, techniques and procedures either known to, or readily developed from known manners, means, techniques and procedures by practitioners of the chemical, material, mechanical, computational and digital arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental and/or calculated support in the following examples.

### EXAMPLES

Reference is now made to the following examples, which together with the above descriptions illustrate some embodiments of the invention in a non-limiting fashion.

### Example 1

A proof of concept of some embodiments of the present invention was carried out by printing an image wherein the design uses a “vintage effect”. Typically the vintage effect is afforded by using a relatively low amount of white ink under-base such that the original colors seem a bit duller. A wash-fastness problem arises from the fact that the white under-base ink is not dense enough in some sections of the image, and the film in not attached well enough to the substrate and fails wash-fastness requirements.

This problem of low wash-fastness due to sparse printing is solved, according to some embodiments of the present invention, by an algorithm that alters the contents of the RIP (Raster Image Processor) information prior to printing. The goal of such algorithm is to ensure each pixel of the image receives enough binder to match or slightly exceed a threshold amount, defined as the minimal or optimal amount of binder needed to achieve a required wash-fastness.

Exemplary Algorithm:

For each printed pixel in the design (image), the exemplary algorithm, according to some embodiments of the present invention, calculates the amount of transparent and colorless ink composition (e.g., clear binder composition, also referred to herein as the n+1 ink) that needs to be added to each pixel of the image in order to comply with the threshold criteria as described hereinabove. The algorithm essentially adds to the RIP printing instructions for the n+1 ink and some margin pixel around the edges of the original image.

The algorithm includes:

a) using a digital form of the image that can be processed by a computer, such as the RIP information, calculating the total amount of ink (by weight or volume) for each pixel of the image, by adding together the amount of ink contributed by each of the colored inks that are to be used in the pixel, thereby obtaining value aₚ;

b) calculating the total amount of ink in a neighboring cluster (pixels surrounding the pixel in a matrix of a 3×3 or 5×5 or 7×7 etc., which may extend beyond the edge of the image), thereby obtaining value b (b=Σaₘ);

c) combining aₚ and b, thereby obtaining value c (aₚ+b=c);

d) multiplying t by the number of pixels in the matrix, thereby obtaining value T;

e) if c<T and aₚ<t, registering an amount of n+1 ink (hereinafter value i) to the pixel, such that t−aₚ=i, updating aₚ to t (aₚ=t) in the RIP and refreshing (recalculating) b and c;

f) if c<T and aₚ≥t, registering i to the neighboring pixel in the matrix with the lowest aₘ that is not zero (aₘ>0), such that t−aₘ=i, updating aₘ to t in the RIP and refreshing b and c;

g) if c<T and each of aₘ≥t, registering i to the neighboring pixel with aₘ=0 such that i=t, updating aₘ to tin the RIP and refreshing b and c; and

h) if c≥T stopping the algorithm and using the updated RIP to print the image.

The above exemplary algorithm, according to some embodiments of the present invention, practically adds a margin of a few pixels to the original image, depending on the size of the matrix, such that a pixel that was on the edge of the image now has at least one neighboring pixel, a margin pixel, which is printed colorless using only the n+1 ink.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method for inkjet printing an image on a surface of a substrate, comprising digitally printing the image on at least a portion of the surface using at least one colored ink composition that comprises a particulate colorant and a binder, and digitally printing a transparent colorless ink composition on at least a portion of the image, wherein:
said transparent colorless ink composition is essentially devoid of a colorant and comprises a binder;
said digitally printing said transparent colorless ink composition is effected on at least one region of impaired adhesion of the image that comprises at least one region of sparse printing, said region of sparse printing is characterized by receiving a total amount of said at least one colored ink composition lower than a threshold;
said threshold is a minimal or optimal amount of said at least one colored ink composition that is sufficient for passing a fastness test; and
a total of said regions of impaired adhesion is equal or larger than a total of said regions of sparse printing, and overlap less than 100% of the image.

2. (canceled)

3. The method of claim 1, wherein said threshold is determined experimentally.

4. The method of claim 1, wherein a printing resolution of said at least one colored ink composition is equal to a printing resolution of said transparent colorless ink composition.

5. The method of claim 1, wherein a printing resolution of said at least one colored ink composition is different than a printing resolution of said transparent colorless ink composition.

6. The method of claim 5, wherein said printing resolution of said transparent colorless ink composition is lower than said printing resolution of said at least one colored ink composition.

7. The method of claim 1, wherein said at least one region of impaired adhesion and said at least one region of sparse printing are co-extensive.

8. The method of claim 1, wherein said at least one region of impaired adhesion is larger than said at least one region of sparse printing.

9. The method of claim 1, wherein said digitally printing said transparent colorless ink composition is effected while the surface is still wet with said at least one colored ink composition and/or said digitally printing said at least one colored ink composition is effected while the surface is still wet with said transparent colorless ink composition.

10. The method of claim 1, further comprising, subsequent to said digitally printing, curing said image.

11. The method of claim 1, further comprising, prior to inkjet printing the image, digitally analyzing a digital form of the image that comprises a position data and information of said total amount of said at least one colored ink composition per each pixel of the image, said analyzing is for identifying said at least one region of sparse printing and determining said regions of impaired adhesion and said minimal or optimal amount of said transparent colorless ink composition per pixel of the image, based on said threshold.

12. A method for identifying at least one region of sparse printing in an image, comprising analyzing a digital form of the image that comprises a position data and information of the total amount of at least one colored ink composition per each pixel of the image, and listing each of said pixels in which said total amount of said at least one colored ink composition is lower than a threshold.

13. The method of claim 12, wherein said threshold is determined experimentally by digitally printing said at least one colored ink composition on a substrate in a predetermined series of shapes, each shape in printed at a different percent ink coverage, curing said predetermined series of shapes on said substrate, subjecting said substrate to a fastness test, and identifying a minimal and/or optimal percent ink coverage, thereby determining said threshold.

14. A product produced by the method of claim 1, wherein the image is characterized by having at least one region of impaired adhesion, identified by a film afforded by curing said transparent colorless ink composition.
